(19) United States
(12) Patent Application Publication
(10) Pub. No.: US 2015/0278469 A1
(43) Pub. Date: Oct. 1, 2015

(54) SYSTEMS AND METHODS FOR DETERMINING AND COMMUNICATING PATIENT ELIGIBILITY FOR AN INTERVENTION SERVICE

(71) Applicant: MCKESSON FINANCIAL HOLDINGS, Hamilton (BM)

(72) Inventors: Summerpal Kahlon, Satellite Beach, FL (US); Andrew Mellin, Saint Paul, MN (US)

(73) Assignee: MCKESSON FINANCIAL HOLDINGS, Hamilton (BM)

(21) Appl. No.: 14/230,142

(22) Filed: Mar. 31, 2014

(51) Int. Cl. G06F 19/00; G06Q 50/18; G06Q 50/22

(52) U.S. Cl. CPC G06F 19/3431; G06F 19/3443; G06Q 50/22; G06Q 50/182

(57) ABSTRACT

Systems and methods are provided for determining an intervention service to provide to a patient and communicating the determined intervention service opportunities to a healthcare provider as part of the processing of a healthcare transaction. A service provider computer may evaluate historical healthcare transaction data for a patient to determine if the patient should receive an intervention service and can store an indication to notify a healthcare provider about the intervention service. A healthcare transaction, such as a prescription billing transaction, may be received by the service provider computer from a healthcare provider computer. The service provider computer may determine if an intervention service has been identified for the patient. The service provider computer may generate a notification of the intervention service, append the notification to an adjudicated response to the healthcare transaction, and transmit the notification and adjudicated response to the healthcare provider computer.

### TECHNICAL FIELD

Aspects of the disclosure relate generally to healthcare transactions and more particularly to systems and methods for determining and communicating services associated with an intervention, such as medication therapy management, that may be available for a patient, as part of the processing of a healthcare transaction.

### BACKGROUND

An intervention is an effort to promote behaviors that optimize mental and physical health of the patient or discourage or reframe behaviors of the patient considered potentially health-averse. One example of an intervention is medication therapy management (MTM). Medication therapy management is medical care provided by pharmacists whose aim is to optimize drug therapy and improve therapeutic outcomes for patients. Medication therapy management includes a broad range of professional activities including, but not limited to, performing patient assessment and/or a comprehensive medication review, formulating a medication treatment plan, monitoring efficacy and safety of medication therapy, enhancing medication adherence through patient empowerment and education, and documenting and communicating MTM services to prescribers in order to maintain comprehensive patient care.

Medication therapy management includes five core components: a medication therapy review, personal medication record, medication-related action plan, intervention and/or referral, and documentation and follow-up. A medication therapy review is a systematic process of collecting patient and medication-related information which occurs during the pharmacist-patient encounter. In addition, the medication therapy review assists in the identification and prioritization of medication-related problems. During the medication therapy management encounter, the pharmacist develops a personal medication record for use by the patient. The personal medication record includes all prescription and non-prescription products/medications and may need to be updated periodically. After assessing and identifying medication-related problems, the pharmacist develops a patient-specific medication-related action plan. The medication-related action plan is a list of self-management actions necessary to achieve the patient's specific health goals. In addition, the patient and pharmacist utilize the medication-related action plan to record actions and track progress towards health goals. During the medication therapy management session, the pharmacist identifies medication-related problems and determines appropriate interventions for resolution. Other examples of interventions include, but are not limited to, a clinician providing recommendations to a patient regarding the need for the patient to have a diagnostic test or receive a medical therapy. Following the patient encounter and/or intervention, the pharmacist may document his/her encounter and determine appropriate patient follow-up.

Providing pharmacies, pharmacy ownership, and service providers a systemized method for identifying patients who are in need of receiving intervention services and processing and tracking patient intervention information associated with an intervention service, such as medication therapy management, can be a challenge with today's pharmacy computer systems. For example, it can be a challenge to notify a pharmacy, within the typical healthcare transaction processing, that a patient is eligible to receive an intervention service, such as an intervention opportunity, associated with a fill and/or refill of a medication. Furthermore, conventional systems do not determine if the intervention service was provided and, if so, provide an option for updating patient intervention service records to identify that the service was provided and, optionally, other information related to the service.

### BRIEF DESCRIPTION OF THE DRAWINGS

Reference will now be made to the accompanying drawings, which are not necessarily drawn to scale, and wherein:

FIG. 1 illustrates an example system for facilitating, among other things, determining and communicating services associated with an intervention opportunity, such as a medication therapy management program, that may be available for a patient as part of the processing of a healthcare transaction, according to one exemplary embodiment.

FIG. 2 illustrates a flow chart of an example method for determining intervention services to provide to each patient in a patient population, according to one example embodiment.

FIG. 3 illustrates an example block diagram for identifying and communicating opportunities to provide intervention services to a patient as part of the processing of a healthcare transaction, according to one example embodiment.

FIGS. 4A-B illustrate a flow chart of an example method for identifying and communicating opportunities to provide intervention services to a patient as part of the processing of a healthcare transaction, according to one example embodiment.

FIG. 5 illustrates a representative patient service form, according to one example embodiment.

FIG. 6 illustrates another representative patient service form, according to one example embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods for determining intervention opportunities for patients and communicating notifications of intervention opportunities, such as a medication therapy management program, that may be available for a patient as part of the processing of a healthcare transaction, such as an eligibility verification request, predetermination of benefits transaction, healthcare claim transaction, prescription claim or billing request, healthcare order transaction, or e-prescription transaction (i.e., electronic prescription order transaction, e-script, or e-prescription). In one example, the available intervention service for each patient may be determined based on patient clinical and claim transaction information stored in a historical database. In some example implementations, a healthcare transaction may be communicated from a pharmacy computer to a service provider computer. In one example, the healthcare transaction may be a National Council for Prescription Drug Programs (NCPDP) Telecommunication Standard formatted healthcare transaction, an American National Standards Institute (ANSI) ASC X12N 837 formatted healthcare transaction, or a message formatted according to the Health Law Seven (HL7) messaging standard.

The service provider computer may deliver the healthcare transaction to a claims processor computer, eligibility verification computer, or other adjudication computer for adjudication of the healthcare transaction. The service provider computer can receive an adjudicated response from, for example, the claims processor computer, which can include an indication of an approved (or paid, eligible, etc.) transaction (e.g., a billing, e-prescribing, or eligibility transaction) or a denied transaction. The service provider computer can determine one or more patient identifiers in the healthcare transaction and determine, based on the patient identifiers, if it has been determined that the patient should receive one or more intervention services.

In one example, the service provider computer may employ an intervention services module to determine whether an intervention service is available for the patient identified in the healthcare transaction. In certain example embodiments, the available intervention service may be determined from patient eligibility information accessed from a intervention notification file. The intervention services module may access an intervention notification file to determine whether a patient intervention service is available and/or recommended for the patient identified in the healthcare transaction. The intervention services module may also determine whether an intervention services notification has previously been sent to the pharmacy computer, communicating availability of the intervention service for the identified patient. If an intervention services notification has not been previously communicated for the patient, the intervention services module may generate an intervention services notification to be communicated to the pharmacy computer along with the adjudicated healthcare transaction response.

The service provider computer can insert a notification to provide intervention services into or otherwise appended to the adjudicated healthcare transaction response and transmit the response to the pharmacy computer. In an alternative example, the notification to provide an intervention service may be communicated to the pharmacy via an email, fax, or text correspondence. In certain examples, this email, fax, and/or text correspondence can also include an attachment, add-on, or internet address link to a patient intervention service form that may be used by the pharmacist or other pharmacy employee in providing the intervention services.

In examples where the pharmacist or other pharmacy employee provides the notified intervention services, a subsequent healthcare transaction can be submitted from the pharmacy computer to the service provider computer providing information regarding provision of the intervention service. The service provider computer can parse the transaction and identify the intervention services provided, the one or more patient identifiers and any additional information related to the provision of the intervention services (e.g., comments from the patient that may trigger other or follow up intervention services, other medications or products that the patient is taking, other medical infirmities of the patient, etc.). In one example, a completed patient intervention service form may be communicated to the service provider computer from the pharmacy computer. The service provider computer may capture and facilitate storage of the intervention information in the patient intervention service form. In certain examples, the service provider computer may also transmit the intervention information to a separate computer system, such as an electronic health record system, a health information exchange computer, a clinical records computer, or other clinical information system. In addition, the intervention information may be transmitted to the healthcare provider via email, facsimile message, text message, phone call, or another communication method.

The service provider computer can update a database record or other file for the patient regarding intervention services needed and completed and can determine what additional intervention services may be recommended at this time. In certain example embodiments, the service provider computer can also forward the subsequent healthcare transaction to the claims processor or other adjudication computer for adjudication. The service provider computer can receive the adjudicated response to the subsequent healthcare transaction and can forward the adjudicated response to the pharmacy computer.

System Overview

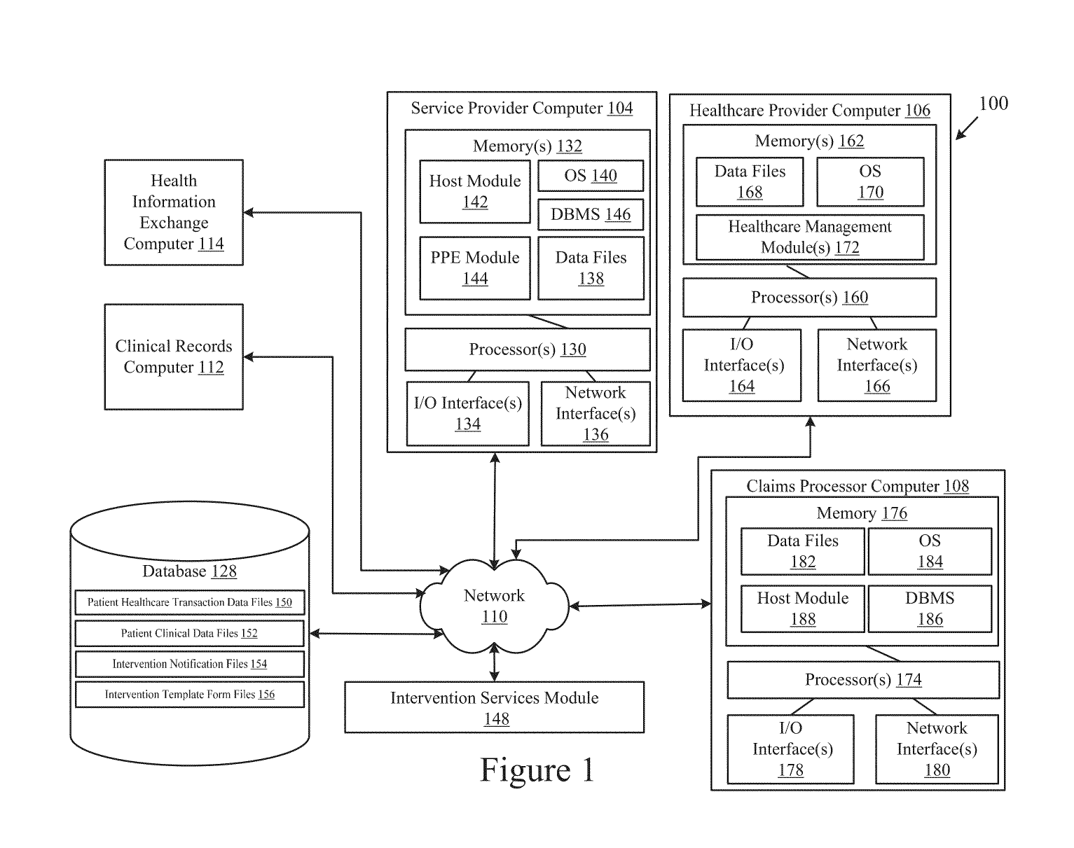

FIG. 1 illustrates an example system 100 for facilitating, among other things, determining intervention service to provide to a patient and communicating intervention services associated with an intervention opportunity, such as a medication therapy management program, that may be available for a patient as part of the processing of a healthcare transaction. As shown in FIG. 1, the system 100 may include one or more service provider computers 104, healthcare provider computers 106, and/or claims processor computers 108. In certain example embodiments, the system 100 may also include one or more clinical records computers 112 and health information exchange computers 114. As desired, each of the service provider computer 104, healthcare provider computer 106, claims processor computer 108, clinical records computer 112 and/or health information exchange computer 114 may include one or more processing devices that may be configured for accessing and reading associated computer-readable media having stored data thereon and/or computer-executable instructions for implementing various embodiments of the disclosure.

Generally, network devices and systems, including one or more service provider computers 104, healthcare provider computers 106, claims processor computers 108, clinical computers 112, and/or health information exchange computers 114 may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the one or more service provider computers 104, healthcare provider computers 106, claims processor computers 108, clinical computers 112, and/or health information exchange computers 114 may be in communication with each other via one or more networks, such as network 110, which may include one or more independent and/or shared private and/or public networks including the Internet or a publicly switched telephone network. In other example embodiments, one or more components of the system 100 may communicate via direct connections and/or communication links. Each of these components—service provider computers 104, healthcare provider computers 106, claims processor computers 108, clinical computers 112, the health information exchange computers 114, and the network 110—will now be discussed in further detail. Although the components are generally discussed as singular components, as may be implemented in various example embodiments, in alternative exemplary embodiments each component may include any number of suitable computers and/or other components.

With continued reference to FIG. 1, one or more service provider computers 104 may be associated with (e.g., located within and/or providing computing services for) a service provider (e.g., a healthcare switch). In certain exemplary embodiments, the service provider computer 104 may be a switch/router that routes healthcare transactions and/or other healthcare requests. For example, the service provider computer 104 may route healthcare transactions, such as eligibility verification requests, predetermination of benefits transactions, healthcare claim transactions, prescription claim or billing requests, healthcare order transactions, or e-prescription transactions (i.e., electronic prescription order transaction, e-script, or e-prescription), communicated from the healthcare provider computer 106 to a claims processor computer 108, such as a pharmacy benefits manager (PBM), an eligibility verification adjudicator, a healthcare insurer, a Medicare payor, other governmental insurance payor, or other third-party insurance payor. The service provider computer 104 may include, but is not limited to, any suitable processor-driven device that is configured for receiving, processing, and fulfilling the healthcare transactions from the healthcare provider computer 106 relating to prescription or other healthcare information including, but not limited to, medications, medication identifiers (e.g., medication name(s), National Drug Code(s) (NDC) codes, RxNorm medication identifiers), quantity of medication to be dispensed, patient identifier information (i.e., name, gender, date of birth, residence address), diagnosis codes, clinical services provided, etc. Any number of healthcare provider computers 106, claims processor computers 108, clinical computers 112, the health information exchange computers 114 may be in communication with the service provider computer 104 as desired in various example embodiments.

The service provider computer 104 may include any number of special-purpose computers or other particular machines, application-specific integrated circuits, microcontrollers, personal computers, minicomputers, mainframe computers, servers, networked computers, and/or other processor-driven devices. In certain embodiments, the operations of the service provider computer 104 may be controlled by computer-executed or computer-implemented instructions that are executed by one or more processors of the service provider computer 104 to form a special-purpose computer or other particular machine that is operable to facilitate the receipt, routing, and/or processing of healthcare requests or healthcare transactions. The one or more processors that control the operations of the service provider computer 104 may be incorporated into the service provider computer 104 and/or may be in communication with the service provider computer 104 via one or more suitable networks. In certain example embodiments, the operations and/or control of the service provider computer 104 may be distributed among several processing components.

The service provider computer 104 may include one or more processors 130, one or more memory devices 132, one or more input/output (“I/O”) interfaces 134, and one or more network interfaces 136. The one or more memory devices 132 may be any suitable memory device, for example, caches, read-only memory devices, random access memory devices, magnetic storage devices, removable storage devices, etc. The one or more memory devices 132 may store data, executable instructions, and/or various program modules utilized by the service provider computer 104, for example, data files 138, an operating system (“OS”) 140, a host module 142, a pre- and post-edit (PPE) module 144, and a database management system (DBMS) 146 to facilitate management of data files 138 and other data stored in the memory devices 132 and/or one or more databases 128. The OS 140 may be any operating system known in the art or which may be developed in the future including, but not limited to, Microsoft Windows®, Apple OSX™, Linux, Unix, Apple iOS™, Google Android™, or a mainframe operating system. The OS 140 may be a suitable software module that controls the general operation of the service provider computer 104 and/or that facilitates the execution of other software modules.

The PPE module 144 may be operable to perform one or more pre-edits on a received healthcare transaction, such as an eligibility verification request, predetermination of benefits transaction, healthcare claim transaction, prescription claim or billing request, healthcare order transaction, or e-prescription transaction (i.e., electronic prescription order transaction, e-script, or e-prescription), prior to routing or otherwise communicating the received healthcare transaction to a suitable claims processor computer 108 or another destination receiver of the transaction. Additionally, the PPE module 144 may be operable to perform one or more post-edits on an adjudicated response that is received from a claims processor computer 108 or another destination receiver for a healthcare transaction prior to routing the adjudicated response to the healthcare provider computer 106. A wide variety of different pre-edits and/or post edits may be performed as desired in various embodiments of the disclosure. In certain example embodiments, an intervention services module 148 and its functions may be incorporated into the PPE module 144 and/or may be in communication with the PPE module 144. Alternatively, the functions of the intervention services module 148 may be, or be part of, a separate computer from the service provider computer 104. In one example embodiment, the functions of the intervention services module 148 may be incorporated into the healthcare provider computer 106 and operable with the service provider computer 104, such as in the form of an application programming interface.

An intervention services module 148 or an intervention services application may also be operative with, or alternatively independent of, the service provider computer 104. The intervention services module 148 may include computer-executable instructions operable for evaluating patient current and/or historical information to determine intervention services to provide to a patient and facilitating the communication of the determined intervention services available for the particular patient. For example, the intervention services module 148 may facilitate receipt of patient clinical data files and patient healthcare transaction data files, and intervention template forms and can facilitate the generation or modification of intervention notification files that can provide an indication of what interventions services should be provided to each patient. The intervention notification file may include, for example, patient identification information (i.e., a patient's first and/or last name, a patient's social security number, a patient's health insurance claim number (HICN), etc.), patient contact information, and/or eligible intervention services information. In one example, eligible intervention services information may include, without limitation, an eligibility group, an eligibility type, an eligibility initiation, and/or an eligibility termination. The intervention services module 148 may facilitate storage of data included in the intervention notification file, patient clinical data files, patient healthcare transaction data files, and/or intervention form templates in one or more suitable databases and/or data storage devices, such as database 128.

In operation, the intervention services module 148 may receive patient clinical data (e.g., lab data, other diagnostic data, electronic health record (EHR) data, medical claims data, socioeconomic data, diagnosis code, other medical infirmity information, or any other clinical or non-clinical data that could help determine if a patient needs an intervention service) and patient healthcare transaction data (e.g., patient information and information identifying medications and products the patient is taking or previously took). Based on this information the intervention services module 148 can identify intervention services to provide to the patient and can store an indication to notify a healthcare provider, such as a pharmacy, to provide, or suggest to provide, the identified intervention services. In addition, the intervention services module 148 may also be operable to receive information associated with a healthcare transaction, an eligibility verification request, predetermination of benefits transaction, healthcare claim transaction, prescription claim or billing request, healthcare order transaction, or e-prescription transaction (i.e., electronic prescription order transaction, e-script, or e-prescription) and/or an adjudicated response to the healthcare transaction. The intervention services module 148 may utilize the intervention notification file 154 to determine the intervention services to provide to the patient identified in the healthcare transaction and to provide any information related to the intervention service into the adjudicated healthcare transaction response. In addition, the intervention services module 148 may identify, such as based on the information in the intervention notification file 154, one or more intervention forms for the corresponding to the identified intervention service included with the healthcare transaction and/or the adjudicated healthcare transaction response. In one example embodiment, the intervention services module 148 may pre-populate the one or more intervention forms with information available from the healthcare transaction and/or adjudicated response. In addition, the intervention services module 148 may be further operable to communicate a response to the healthcare provider computer 106. The response, in one example, may also include the one or more pre-populated intervention forms.

In certain example embodiments the intervention services module 148 may be further operable to receive communication from the healthcare provider computer 106. In one example, the intervention services module 148 may receive a healthcare transaction or other communication that provides an indication that an intervention service was completed for a particular patient. In certain example embodiments, the intervention services module 148 can also receive, from the healthcare provider computer 106, one or more intervention forms completed for/by a patient. For example, upon receipt of the response and the one or more intervention forms, a pharmacist or other pharmacy employee at the pharmacy associated with the healthcare provider computer 106 may access the intervention forms and present the forms to a patient and/or patient caregiver at the time the prescription identified with the healthcare transaction is received by the patient and/or patient caregiver. The intervention services module 148 may be further operable to facilitate storage of data, including the patient completed intervention forms, in one or more suitable databases and/or data storage devices, such as the database 128.

According to an example embodiment, the data files 138 may store healthcare transaction records associated with communications received from various healthcare provider computers 106, various claims processor computers 108, various clinical records computers 112, and/or various health information exchange computers 114. The data files 138 may also store any number of suitable routing tables that facilitate determining the destination of communications received from a healthcare provider computer 106, a claims processor computer 108, a clinical records computer 112, and/or a health information exchange computer 114.

With continued reference to the service provider computer 104, the one or more I/O interfaces 134 may facilitate communication between the service provider computer 104 and one or more input/output devices, for example, one or more user interface devices, such as a display, keypad, control panel, mouse, touch screen display, remote control, microphone, etc., that facilitate user interaction with the service provider computer 104. The one or more network interfaces 136 may facilitate connection of the service provider computer 104 to one or more suitable networks, for example, the network 110 illustrated in FIG. 1. In this regard, the service provider computer 104 may communicate with other components of the system 100, such as the sponsor computer 102, the healthcare provider computers 106, the claims processor computers 108 and the database 128.

The service provider computer 104 may include additional program modules for performing other processing methods described herein. Those of ordinary skill in the art will appreciate that the service provider computer 104 may include alternate and/or additional components, hardware, or software without departing from the scope of the disclosure.

With continued reference to FIG. 1, any number of healthcare provider computers 106 (e.g., pharmacy computer, hospital computer, physician's computer, clinic computer) may be associated with (e.g., located within and/or providing computing services for) any number of healthcare providers (e.g., pharmacies and/or pharmacists, hospital, physician's office, clinic). Each healthcare provider computer 106 may be any suitable processor-driven device that facilitates generating, communicating, processing, and/or fulfilling healthcare transactions such as an eligibility verification request, predetermination of benefits transaction, healthcare claim transaction, prescription claim or billing request, healthcare order transaction, or e-prescription transaction (i.e., electronic prescription order transaction, e-script, or e-prescription) received from or transmitted to the service provider computer 104. For example, a healthcare provider computer 106 may be a processor-driven device associated with (i.e., located within and/or otherwise providing computing services for) a pharmacy. As desired, the healthcare provider computers 106 may include any number of special-purpose computers or other particular machines, application-specific integrated circuits, microcontrollers, personal computers, minicomputers, mainframe computers, servers, and the like. In certain example embodiments, the operations of the healthcare provider computers 106 may be controlled by computer-executed or computer-implemented instructions that are executed by one or more processors associated with the healthcare provider computer 106 to form a special-purpose computer or other particular machine that is operable to facilitate the receipt, generation, and/or fulfillment of healthcare transactions (e.g., an eligibility verification request, predetermination of benefits transaction, healthcare claim transaction, prescription claim or billing request, healthcare order transaction, or e-prescription transaction (i.e., electronic prescription order transaction, e-script, or e-prescription)). The one or more processors 160 that control the operations of the healthcare provider computer 106 may be incorporated into the healthcare provider computer 106 and/or may be in communication with the healthcare provider computer 106 via one or more suitable networks. In certain example embodiments, the operations and/or control of the healthcare provider computer 106 may be distributed among several processing components.

Similar to other components of the system 100, each healthcare provider computer 106 may include one or more processors 160, one or more memory devices 162, one or more I/O interfaces 164, and one or more network interfaces 166. The one or more memory devices 162 may be any suitable memory devices, for example, caches, read-only memory devices, random access memory devices, magnetic storage devices, removable memory devices, etc. The one or more memory devices 162 may store data, executable instructions, and/or various program modules utilized by the healthcare provider computers 106, for example, data files 168, an OS 170, and a healthcare management module 172. The data files 168 may include any suitable information that is utilized by the healthcare provider computers 106. The OS 170 may be a suitable software module that controls the general operation of the healthcare provider computer 106. The OS 170 may also facilitate the execution of other software modules by the one or more processors 160. The OS 170 may be any operating system known in the art or which may be developed in the future including, but not limited to, Microsoft Windows®, Apple OSX™, Linux, Unix, Apple iOS™, Google Android™, or a mainframe operating system.

The one or more I/O interfaces 164 may facilitate communication between the healthcare provider computer 106 and one or more input/output devices, for example, one or more user interface devices, such as a display, keypad, control panel, mouse, touch screen display, remote control, microphone, etc., that facilitate user interaction with the healthcare provider computers 106. The one or more network interfaces 166 may facilitate connection of the healthcare provider computer 106 to one or more suitable networks, for example, the network 110. In this regard, the healthcare provider computer 106 may receive healthcare transactions, adjudicated responses, intervention services information, and/or other communications from the service provider computer 104 and the healthcare provider computers 106 may communicate healthcare transactions, information associated with processing healthcare transactions and/or intervention services information to the service provider computer 104.

The healthcare management module 172 may be a software application(s), including a dedicated program, for fulfilling healthcare transaction orders, reading and/or updating medical records (e.g., patient healthcare transaction data files 150), facilitating patient billing, etc., as well as interacting with the service provider computer 104. For example, a healthcare provider (e.g., pharmacist, physician, nurse, etc.) or other healthcare provider employee (e.g., pharmacy employee, hospital employee, clinic employee, doctor's office employee, etc.) may utilize the healthcare management module 172 in filling a prescription, recording and/or updating a patient's medical prescription history, and billing, generating, preparing, and providing a healthcare transaction to the service provider computer 104. Furthermore, the healthcare provider computer 106 may utilize the healthcare management module 172 to retrieve or otherwise receive data, messages, or responses from other components of the system 100.

With continued reference to FIG. 1, each of the claims processor computers 108 may be any suitable processor-driven device that facilitates receiving, processing (e.g., adjudicating), and/or responding to healthcare transactions received from the service provider computer 104. For example, the claims processor computer 108 may be a processor-driven device associated with (e.g., located within and/or otherwise providing computing services for) a claims processor (i.e., Pharmacy Benefits Manager (PBM), claims payor, healthcare insurance company, Medicare, Medicaid, or other government healthcare insurance payor, Medicare Part D provider, eligibility adjudicator, claims clearinghouse, etc.). As desired, the claims processor computer 108 may include any number of special purpose computers or other particular machines, application specific circuits, microcontrollers, personal computers, minicomputers, mainframe computers, servers, and the like. In certain embodiments, the operations of the claims processor computer 108 may be controlled by computer-executed or computer-implemented instructions that are executed by one or more processors associated with the claims processor computer 108 to form a special purpose computer or other particular machine that is operable to facilitate the receipt, processing, and/or responding to healthcare transactions received from the service provider computer 104. The one or more processors that control the operations of the claims processor computer 108 may be incorporated into the claims processor computer 108 and/or in communication with the claims processor computer 108 via one or more suitable networks, such as network 110. In certain example embodiments of the disclosure, the operation and/or control of the claims processor computer 108 may be distributed amongst several processing components. In an alternate embodiment, the functions of the claims processor computer 108 may be incorporated into the service provider computer 104 and/or the eligibility services module 148.

Similar to other components of the system 100, the claims processor computer 108 may include one or more processors 174, one or more memory devices 176, one or more input/output (I/O) interfaces 178, and one or more network interfaces 180. The memory 176 may be any suitable memory devices, for example, caches, read only memory devices, random access memory devices, magnetic storage devices, removable memory devices, etc. The one or more memory devices 176 may store data, executable instructions, and/or various program modules utilized by the claims processor computer 108, for example, data files 182, an operating system (OS) 184, a database management module (“DBMS”) 186, and a host module 188. The data files 182 may include any suitable information that is utilized by the claims processor computer 108 to process healthcare transactions, for example, patient profiles, patient insurance information, other information associated with a patient, information associated with a healthcare provider, claims processing rules, etc.

The OS 184 may be a suitable software module that controls the general operation of the claims processor computer 108. The OS 184 may also facilitate the execution of other software modules by the one or more processors 174, for example the DBMS 186 and/or the host module 188. The OS 184 may be any operating system known in the art or which may be developed in the future including, but not limited to, Microsoft Windows®, Apple OSX™, Linux, Unix, Apple iOS™, Google Android™, or a mainframe operating system. The DBMS 186 may be a suitable software module that facilitates access and management of one or more databases that are utilized to store information that is utilized by the claims processor computer 108 in various embodiments of the disclosure. The host module 188 may initiate, receive, process, and/or respond to requests, such as healthcare transactions, from the host module 142 of the service provider computer 104.

The I/O interface(s) 178 may facilitate communication between the processors 174 and various I/O devices, such as a keyboard, mouse, printer, microphone, speaker, monitor, bar code reader/scanner, RFID reader, and the like. The one or more network interface(s) 180 may facilitate connection of the claims processor computer 108 to one or more suitable networks, for example, network 110. In this regard, the claims processor computer 108 may receive healthcare transactions and/or other communications from the service provider computer 104, and the claims processor computer 108 may communicate information associated with the processing and adjudication of the healthcare transactions to the service provider computer 104.

The claims processor computer 108 may include additional program modules for performing other pre-processing, as processed, and/or post-processing methods described herein. Those of ordinary skill in the art will appreciate that the claims processor computer 108 may include alternate and/or additional components, hardware or software without departing from example embodiments of the disclosure.

With continued reference to FIG. 1, a clinical records computer 112 may be separate and distinct from or operative with the service provider computer 104. The clinical records computer 112 may include computer-executable instructions for receiving healthcare transactions covering patient visit information at a healthcare provider (e.g., patient laboratory information (e.g., lab results), patient clinical information (e.g., clinical findings), patient progress notes, medication history, diagnosis information (e.g., diagnosis code(s)) admit, discharge, transfer (ADT) transactions, etc.) from multiple healthcare providers. Each of these healthcare transactions may include one or more diagnosis codes identifying or otherwise representing infirmities/illnesses being suffered by the patient, as determined by a healthcare provider (e.g., doctor, nurse, nurse practitioner, etc.) associated with the healthcare provider computer 106. The clinical records computer 112 may provide all or a portion of the information in these healthcare transactions to the service provider computer 104 for storage in the patient clinical data files 152 and for analysis to determine potential intervention services to provide to the each patient. Thus, the clinical records computer 112 can conform multiple types and forms of transactions from multiple distinct healthcare provider computers 106 and provide that data to the service provider computer 104 for intervention services determinations. In certain example embodiments, the clinical records computer 112 may be implemented as part of the memory 132 of the service provider computer 104. Alternatively, the clinical records computer 112 may be implemented as computer-executable instructions of a memory of a separate processor-based system, according to an example embodiment of the disclosure.

With continued reference to FIG. 1, a health information exchange computer 114 may be separate and distinct from or operative with the service provider computer 104. The health information exchange computer 114 may include computer-executable instructions for receiving patient healthcare data from a variety of healthcare providers. In one example, the health information exchange computer 114 may receive data in one format and modify that data to be readable in another format. For example, data may be received by the health information exchange computer 114 in NCPDP format, American National Standards Institute (ANSI) ASC X12N 837 format, consolidated clinical document architecture (C-CDA), or any other known formatting standard and may be reformatted by the health information exchange computer 114 to satisfy the HL7 formatting standard. The health information exchange computer 114 may provide all or a portion of the information in the healthcare data accessible to or stored within the health information exchange computer 114 to the service provider computer 104 for storage in the patient clinical data files 152 and for analysis to determine potential intervention services to provide to the each patient. Thus, the health information exchange computer 114 can conform multiple types and forms of transactions from multiple distinct healthcare provider computers 106 and provide that data to the service provider computer 104 for intervention services determinations. In certain example embodiments, the health information exchange computer 114 may be implemented as part of the memory 132 of the service provider computer 104. Alternatively, the health information exchange computer 114 may be implemented as computer-executable instructions of a memory of a separate processor-based system, according to an example embodiment of the disclosure.

In one or more example embodiments of the disclosure, the service provider computer 104 may include or otherwise be in communication with one or more suitable databases and/or data storage devices 128, which may include, but are not limited to, one or more patient healthcare transaction data files 150, one or more patient clinical data files 152, one or more intervention notification files 154 and/or one or more intervention template forms files 156. The patient healthcare transaction files 150 may include medication history data for a multitude of patients. The patient healthcare transaction file 150 may include, without limitation, information (e.g., patient identification information (e.g., patient social security number, a subset of the patient social security number, a health insurance claim number (HICN), cardholder ID, etc., a patient name, a patient gender, a patient date of birth, a patient address, a patient phone number, and/or an email address), medication identifiers, quantity dispensed, days' supply, prescriber identifier, pharmacy identifier, and diagnosis code (if included)) captured by the service provider computer 104 as part of its processing of healthcare transactions.

The patient clinical data files 152 may include clinical and hospital data records for a multitude of patients. The patient clinical data files 152 may include, without limitation, patient identification information (i.e., patient social security number, a subset of the patient social security number, a health insurance claim number (HICN), cardholder ID, etc., a patient name, a patient gender, a patient date of birth, a patient address, a patient phone number, and/or an email address), one or more diagnosis codes identifying medical infirmities of the patient, medical test data, patient physiological data, etc. The patient clinical data files or the data therein can be received from the clinical records computer 112 and/or the health information exchange computer 114 by the intervention services module 148 or another portion of the service provider computer 104.

The intervention notification files 154 may include patient identification information (e.g., patient social security number, a subset of the patient social security number, a health insurance claim number (HICN), cardholder ID, etc., a patient name, a patient gender, a patient date of birth, a patient address, a patient phone number, and/or an email address), an indication of the intervention services received by the identified patient, the date and/or time the intervention services were provided, the healthcare provider (e.g., pharmacy, clinic, hospital, etc.) providing the intervention service, and/or an indication of the intervention services currently suggested to be provided to the identified patient. In one example embodiment, the identification of intervention services suggested to be provided to each patient may be determined by the intervention services module 148 based, at least in part, on information in the patient healthcare transaction data files 150 and/or the patient clinical data files 152. The intervention notification files 154 may also include eligibility information, for example, without limitation, an eligibility group, an eligibility type, an eligibility initiation, an eligibility termination, and the like.

The intervention notification files 154 may also include, without limitation, one or more previously communicated intervention forms and/or one or more intervention notifications (e.g., “INTERVENTION OPPORTUNITY—RESUBMIT CLAIM, ACCESS PHARMACY EMAIL IF PAID RESPONSE FOLLOWS, PRINT PATIENT INTERVENTION FORM, ASSOCIATE WITH RX.”). The one example embodiment, intervention notification files 154 may be organized by an intervention notification ID that may be assigned by the intervention services module 148 or another portion of the service provider computer 104.

The intervention template forms files 156 may include, without limitation, one or more paper and/or electronic template intervention forms. For example, the one or more template intervention forms may be organized according to an intervention type identifier (e.g., XX), an intervention template (e.g., standardized information to be applied to each intervention type), a medication and/or product type, and the like.

The network 110 may include any telecommunications and/or data network, whether public, private, or a combination thereof, including a local area network, a wide area network, an intranet, the Internet, intermediate handheld data transfer devices, and/or any combination thereof and may be wired and/or wireless, or any combination thereof. The network 110 may also allow for real time, offline, and/or batch transactions to be transmitted between or among the service provider computer 104 (including or separate from the intervention services module 148), the healthcare provider computer 106, the claims processor computer 108, the clinical records computer 112, the health information exchange computer 114, and/or the database 128. Various methodologies, as described herein, may be practiced in the context of distributed computing environments. Although the service provider computer 104 is shown for simplicity as being in communication with the healthcare provider computer 106, the claims processor computer 108, the clinical records computer 112, the health information exchange computer 114, and/or the database 128 via one intervening network 110, it is to be understood that any other network configurations are possible. For example, intervening network 110 may include multiple networks, each with devices such as gateways and routers for providing connectivity between or among the components of the system 100. Instead of, or in addition to, the network 110, dedicated communication links may be used to connect various devices in accordance with an example embodiment. For example, the service provider computer 104 may form the basis of network 110 that interconnects the service provider computer 104 (including or separate from the intervention services module 148), the healthcare provider computer 106, the claims processor computer 108, the clinical records computer 112, the health information exchange computer 114, and/or the database 128.

Those of ordinary skill in the art will appreciate that the system 100 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the service provider computer 104 (or other computer) may be implemented as a specialized processing machine that includes hardware and/or software for performing the methods described herein. Accordingly, embodiments of the disclosure should not be construed as being limited to any particular operating environment, system architecture, or device or network configuration.

Operational Overview

Certain portions of the exemplary methods below will be described with reference to determining intervention services to provide to patients based on historical patient clinical and/or medication data and communicating instructions to provide the determined intervention services for a patient as part of the processing of a healthcare transaction. While the methods described below are described with reference to a prescription claim or billing request, each form of a healthcare transaction, such as an eligibility verification request, predetermination of benefits transaction, healthcare claim transaction, prescription claim or billing request, healthcare order transaction, or e-prescription transaction (i.e., electronic prescription order transaction, e-script, or e-prescription), should be individually read as being used in the methods described below. In addition, while certain methods below are described with reference to the intervention service being an MTM service, this is also for example only and all other intervention services should be individually read as being used in the methods below.

In addition, the exemplary methods below will be described with reference to a pharmacy computer 106 as the healthcare provider computer and being associated with (e.g., located within and/or providing computing services for a pharmacy as the healthcare provider. However, this reference to the pharmacy computer 106 and pharmacy as the healthcare provider computer and healthcare provider is solely for purposes of example, as any other healthcare provider, such as a doctor, hospital, urgent care center, clinic, dentist, physician's assistant, nurse, clinical pharmacist, or any other person or entity permitted to prescribe healthcare services to a patient, could be substituted for, and should each be individually read as being a part of each of these methods.

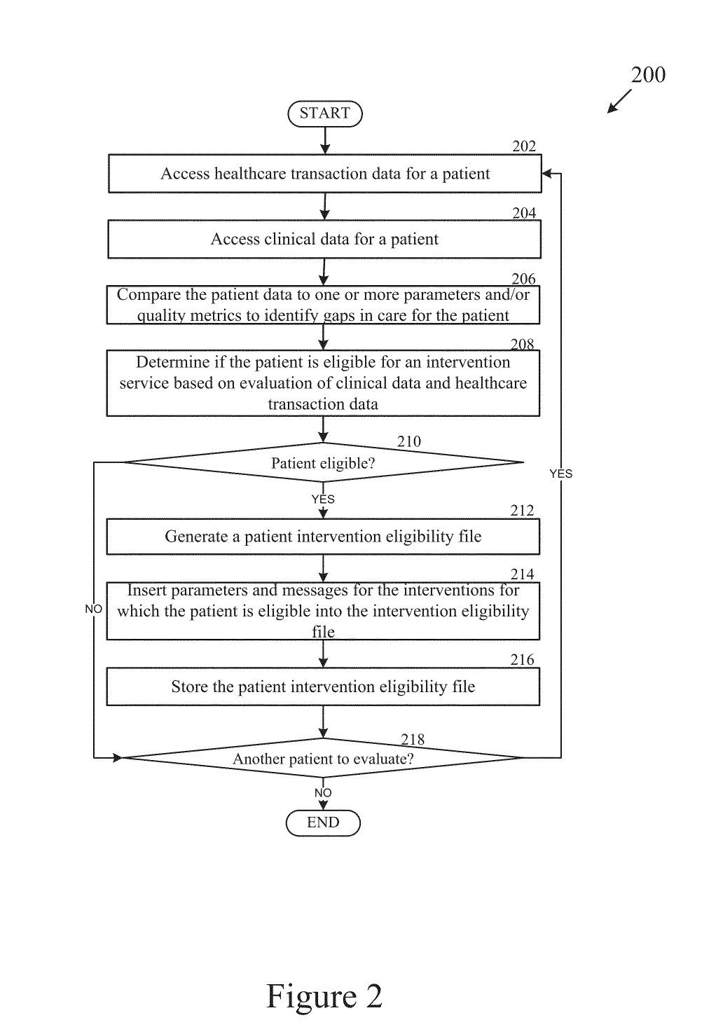

FIG. 2 is a flow chart illustrating an example method 200 for determining intervention services to provide to each patient in a patient population, according to an example embodiment of the disclosure. Referring now to FIGS. 1 and 2, the exemplary method 200 begins at the START step and continues to step 202, where the intervention services module 148 or another portion of the service provider computer 104 can access healthcare transaction data for a patient. For example, the intervention service module 148 can identify or otherwise select a patient and access healthcare transaction data for the patient from the patient healthcare transaction data files 150 in the database 128. The example, healthcare transaction data can include, but is not limited to, patient identification information (e.g., patient social security number, a subset of the patient social security number, a health insurance claim number (HICN), cardholder ID, etc., a patient name, a patient gender, a patient date of birth, a patient address, a patient phone number, and/or an email address), medication identifiers, quantity dispensed, days' supply, prescriber identifier, pharmacy identifier, and diagnosis code.

In step 204, clinical data for the patient can be accessed. In one example, the clinical data can be accessed by the intervention services module 148 or another portion of the service provider computer 104 and can be retrieved from the patient clinical data files 152 in the database 128. The patient clinical data files 152 may include clinical and hospital data records for a multitude of patients. For example, the patient clinical data files 152 may include, without limitation, patient identification information (i.e., patient social security number, a subset of the patient social security number, a health insurance claim number (HICN), cardholder ID, etc., a patient name, a patient gender, a patient date of birth, a patient address, a patient phone number, and/or an email address), one or more diagnosis codes identifying medical infirmities of the patient, medical test data, patient physiological data, etc. In certain example embodiments, only one of steps 202 and 204 may be completed. In step 206, the intervention services module 148 can compare the accessed patient data for the patient to one or more parameters and/or quality metrics to identify gaps in care for the patient and/or to identify intervention services, such as MTM services, to bridge those gaps. In step 208, as part of the comparison, the intervention services module 148 can determine if the patient is eligible for an intervention service.

An MTM service, one of multiple optional intervention services available to a patient, may include a broad range of services. For example, without limitation, an intervention service may involve a patient assessment, a comprehensive medication review, formulating a medication treatment plan for a patient, enhancing medication adherence through patient education, monitoring efficacy and safety of medication therapy, and the like.

In one example implementation, the intervention services module may determine that an intervention service should be provided to a patient based upon a medication and/or product associated with an intervention service type. In one example, the intervention services module 148 may identify intervention services to provide to the patient based upon a medication and/or product type (i.e., a medication/product identifier, a medication/product name, or the like) identified in an accessed patient healthcare transaction data file 150. In another example, the intervention services module 148 may identify an intervention service to provide to the patient based upon an infirmity of the patient identified, for example, based on the diagnosis code in clinical data from the patient clinical data files 152. In yet another example, the intervention services module 148 may identify an intervention service for the patient based on a comparison of medication/product data from the patient healthcare transaction data files 150 and data in the one or more patient clinical data files 152. Alternatively, the intervention services module 148 may identify an intervention service based upon a patient demographic such as, without limitation, a patient age and/or a patient gender. In another example, the intervention services module 148 may determine if the patient is due to have an influenza or other type of vaccination. In yet another example, the intervention services module 148 can determine that the patient has a specific infirmity and that, based on that identified infirmity, the patient needs one or more clinical tests. For example, the intervention services module 148 can determine that a patient has diabetes and based on that determination, the intervention services module can determine if the patient has received a hemoglobin A1C test in a predetermined and configurable amount of time. If the patient has not received the hemoglobin A1C test in the predetermined amount of time, the intervention services module 148 can identify the hemoglobin A1C test as an intervention service for the patient.

In step 210, an inquiry is conducted to determine if the patient is eligible to receive one or more intervention services. In one example embodiment, the determination is made by the intervention services module 148. Put another way, the intervention services module 148 determines, optionally based on healthcare transaction data, clinical data and/or patient demographic data if the patient should receive a particular intervention service. If an intervention service is not identified for the patient, the NO branch is followed to step 218. On the other hand, if the intervention services module 148 identifies an intervention service for the patient, the YES branch is followed to step 212, where the intervention services module 148 can generate an intervention eligibility file. In one example, the intervention eligibility file may provide information about the patient and the one or more interventions identified as those that should be provided to the patient. For example, the intervention eligibility file may include, but is not limited to, one or more of the following fields:
Unique Patient ID
Banking Identification Number (BIN) Number:
Processor Control Number (PCN)
Group ID
Cardholder ID
Person Code
Patient Last Name
Patient First Name
Patient Date of Birth
Social Security #(SSNID)
Patient Gender Code
Patient Street Address 1
Patient Street Address 2
Patient City Address
Patient State/Province Address
Patient ZIP/Postal Zone
Primary Phone Number
Primary Phone Number Type
Eligibility Group:
Eligibility Type:
Eligibility Initiation:
Eligibility Termination: and
Patient Clinical Data Relevant to the Intervention.

In step 214, the intervention services module 148 can insert parameters and messages for the interventions that have been determined for the patient into the intervention eligibility file. The intervention services module 148 or another portion of the service provider computer 104 can store the intervention eligibility file for the patient in step 216. In one example, the file can be stored in the intervention notification files 154 in the database 128. For example, the intervention eligibility file for the patient can be stored and the eligibility services module 148 can monitor healthcare transactions until a healthcare transaction for the particular patient is identified. Prior to the healthcare transaction, such as an adjudicated healthcare transaction response, being transmitted back to the healthcare provider computer 106, the intervention services module 148 can insert a notification to provide intervention services retrieved from the intervention notification files 154 and identified in the intervention eligibility file for the patient.

In step 218, an inquiry is conducted to determine if there is another patient for which an intervention services evaluation needs to be completed. In certain example embodiments, the intervention services evaluations for patients are completed on a configurable periodic basis, such as daily, weekly, biweekly, monthly, bimonthly, quarterly, annually, or any period therebetween. In one example embodiment, the determination is made by the intervention services module 148 or another portion of the service provider computer 104.

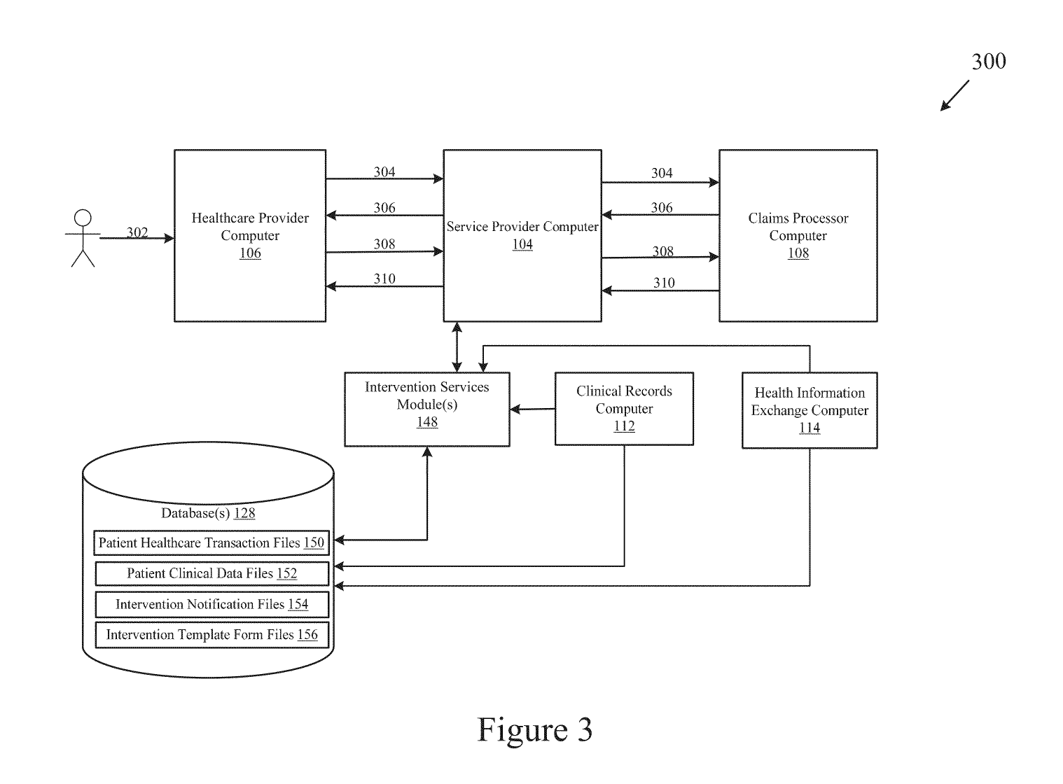

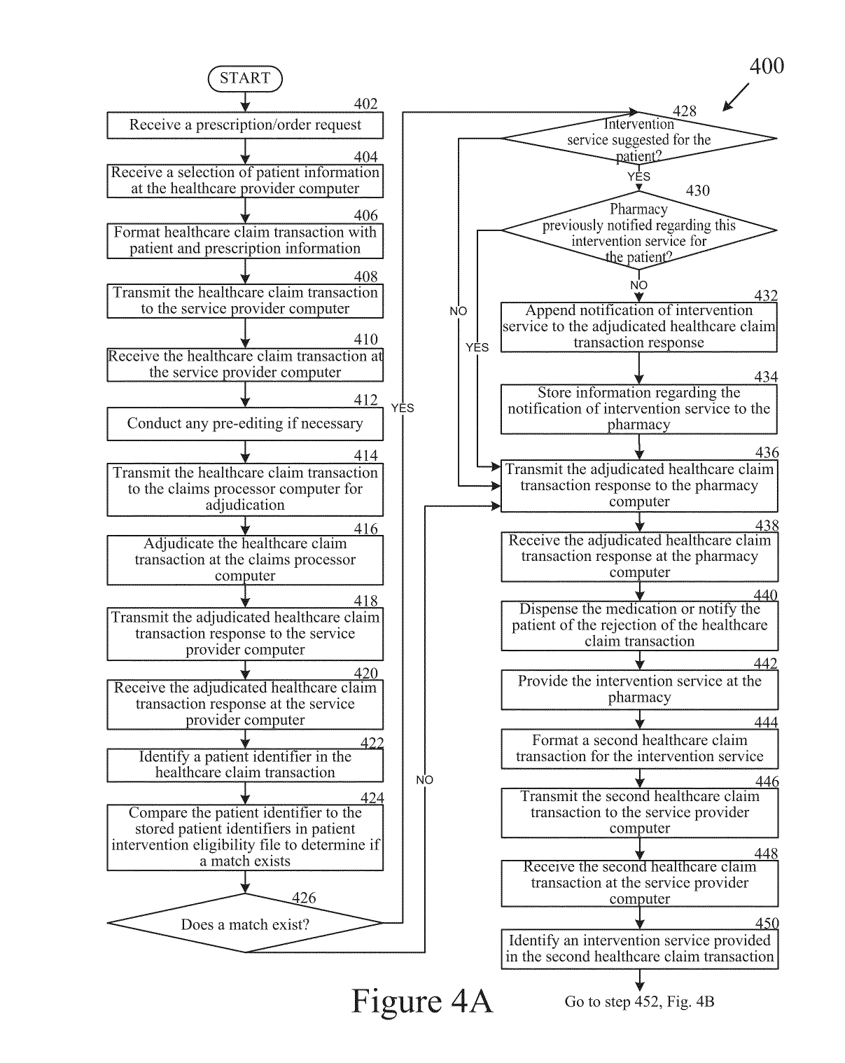

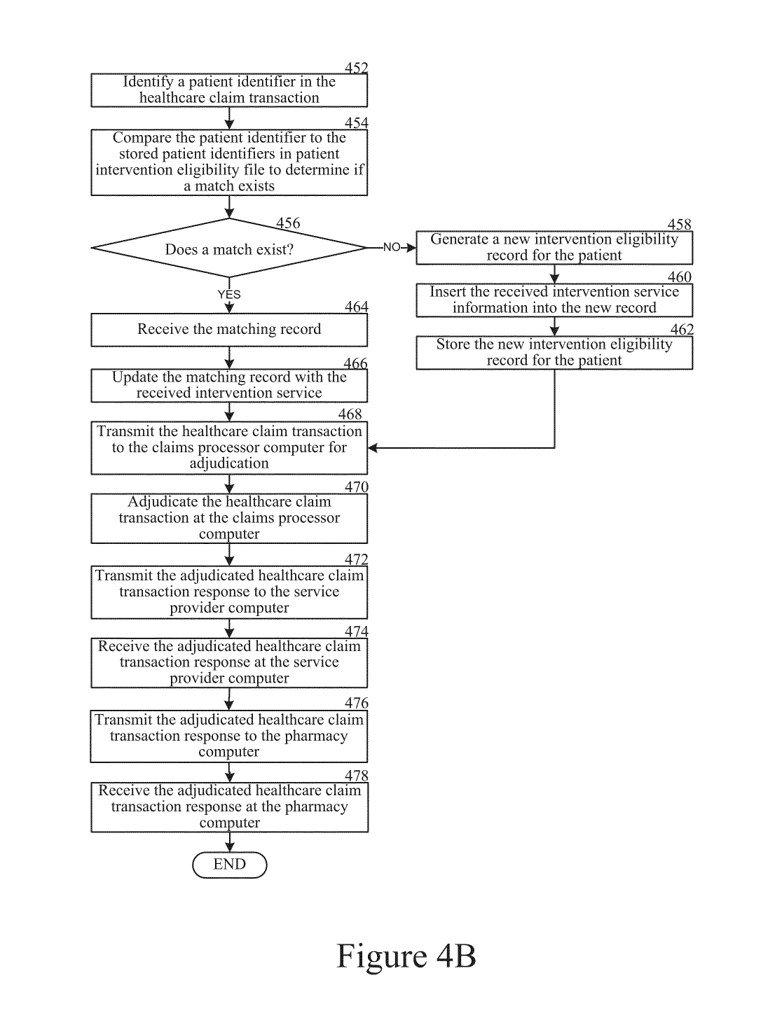

FIG. 3 illustrates an example block diagram for identifying and communicating opportunities to provide intervention services to a patient as part of the processing of a healthcare transaction submitted by a healthcare provider, such as a pharmacy via a pharmacy computer 106, according to an example embodiment of the disclosure. FIGS. 4A-B illustrate an example method 400 for identifying and communicating opportunities to provide intervention services to a patient as part of the processing of a healthcare transaction submitted by a healthcare provider, such as a pharmacy via a pharmacy computer 106, according to an example embodiment of the disclosure. Referring now to FIGS. 1, 3, and 4A-B the exemplary method 400 begins at the START step and continues to step 402, where a prescription/order request 302 is received. In one example embodiment, the prescription/order request 302 is received by a pharmacist at a pharmacy.

The prescription/order request 302 may be received from a patient, another healthcare provider prescribing a medication or service (e.g., physician, hospital, clinic, etc.), by phone, via the Internet, via an electronic prescription (i.e., electronic prescription order transaction, e-script, or e-prescription) such as from a prescriber healthcare provider computer 106 or by way of an electronic system order. For example, the prescription 302 may be received by the patient from a prescriber of the medication, such as a doctor, dentist, nurse, or physician's assistant. The patient may go to the location of the pharmacy and physically hand the prescription request 302 to the pharmacist or make a request via a web portal communicably coupled to the pharmacy computer 106 or an IVR communicably coupled or otherwise providing order data to the pharmacy computer 106. The pharmacist determines the patient's name and accesses the pharmacy computer 106, which receives a selection of patient information from the pharmacist via the I/O interface 164 in step 404. For example, the pharmacist accesses the pharmacy computer 106 and accesses a database of patient information, which may be stored in memory 162 or in another database either local or remote from the pharmacy computer 106. The pharmacist can then select the name or other patient identification information in the patient information database that matches the name or other identification information of the patient. In certain example embodiments, this information from the database includes the Payor ID/routing information (e.g., Banking Identification Number (BIN) Number, BIN Number and Processor Control Number (PCN), and/or BIN Number and Group ID) that identifies the claims processor computer 108 intended to receive and adjudicate the healthcare transaction 304.

In step 406, a healthcare transaction 304, such as a prescription billing transaction, is generated and/or formatted at the pharmacy computer 106. In certain exemplary embodiments, the pharmacy computer 106 formats the prescription billing transaction 304 with patient information, Payor ID/routing information, and medication information. The information can be input into the prescription billing transaction 304 by the pharmacist via the I/O interface 164 or automatically retrieved and entered by the pharmacy computer 106 based at least in part on historical transaction information for the patient in the data files 168 or a database communicably coupled to the pharmacy computer 106. According to one example embodiment, the prescription billing transaction 304 may be formatted in accordance with a version of the National Council for Prescription Drug Programs (NCPDP) Telecommunication Standard, the American National Standards Institute (ANSI) ASC X12N 837 format, or the HL7 messaging format. In another example embodiment other messaging standards may be utilized for formatting the prescription billing transaction 304.

As discussed above, the prescription billing transaction 304 may include a BIN Number, a BIN Number and PCN, and/or a BIN Number and Group ID for identifying a particular claims processor computer (i.e., PBM, payor, healthcare insurance company, Medicare or other government healthcare insurance payor, Medicare Part D provider, etc.), such as the claims processor computer 108, as a destination for the prescription billing transaction 304. In addition, the prescription billing transaction 304 may also include information relating to the patient, payor, prescriber, healthcare provider, and/or the requested medication. As an example, the healthcare claim transaction 304 may include one or more of the following information:

Payor ID/Routing Information
BIN Number (i.e. Banking Identification Number), BIN Number and Processor Control Number (PCN) and/or BIN Number and Group ID, that designates a destination of the healthcare claim transaction 204

Patient Information
Name (e.g. Patient Last Name, Patient First Name, etc.)
Date of Birth of Patient
Age of Patient
Gender
Patient Address (e.g. Street Address, Zip Code, etc.)
Patient Contact Information (e.g. patient telephone number, email address, etc.)
Patient Health Condition Information
Patient ID or other identifier (e.g., Health Insurance Claim Number (HICN), social security number, etc.)

Insurance/Coverage Information
Cardholder Name (e.g. Cardholder First Name, Cardholder Last Name)
Cardholder ID and/or other identifier (e.g. person code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Medication, service, or product identifier (e.g. National Drug Code (NDC) code, RxNorm code, etc.)
Prescription/Service Reference Number
Date Prescription Written
Quantity Dispensed
Days' Supply
Diagnosis/Condition (e.g., diagnosis code)
Pricing information for the drug/service/product (e.g. network price, Usual & Customary price)
Number of Refills Authorized
One or more NCPDP Message Fields
One or more Drug Utilization (DUR) Codes
Date of Service.

The prescription billing transaction 304 can be used to determine if the claims processor associated with the claims processor computer 108 approves or rejects payment coverage for medication being requested in the prescription billing transaction 304 and, if approved, the amount the claims processor will cover (or pay) for the medication being requested and how much the patient co-pay amount will be. In another example, the healthcare transaction 304, such as an X12 270 eligibility verification request, can be used to determine if the eligibility adjudicator associated with the claims processor computer 108 determines if the patient identified in the transaction 304 has the requested insurance coverage and/or an identification of the coverage levels for the patient. Alternatively, in situations where the healthcare transaction is a e-prescription transaction (i.e., electronic prescription order transaction, e-script, or e-prescription) the transaction can be used to transmit a prescription from the prescriber healthcare provider, via the prescriber healthcare provider computer, to the pharmacy, via the pharmacy healthcare provider computer 106 by way of the service provider computer 104.

The pharmacy computer 106 transmits the prescription billing transaction 304 to the service provider computer 104 in step 408. In step 410, the service provider computer 104 receives the prescription billing transaction 304. For example, the prescription billing transaction 304 can be transmitted by the pharmacy computer 106 to the service provider computer 104 through the network 110. The service provider computer 104 conducts any pre-editing, if necessary, on the prescription billing transaction 304 in step 412. The pre-edits may include verifying, adding, and/or editing information included in the prescription billing transaction 304 prior to it being communicated to a claims processor computer 108 or the pharmacy computer 106. For example, the service provider computer 104 can parse the prescription billing transaction 304 to determine/edit the financial fields, the service code, the quantity dispensed, and or the patient age. In addition, the service provider computer 104 can determine whether one or more intervention services should be provided to the patient identified in the prescription billing transaction 304 as discussed below.

The service provider computer 104 transmits the prescription billing transaction 304 to the claims processor computer 108 for adjudication in step 414. For example, a prescription billing transaction 304 can be transmitted from the service provider computer 104 to the claims processor computer 108 via the network 110. The claims processor computer 108 receives and adjudicates the prescription billing transaction 304 in step 416 to determine if the patient has coverage, to determine to what extent the patient's coverage covers the requested medication identified in the prescription billing transaction 304, and to generate an adjudication 306 as to whether the prescription billing transaction 304 is approved or rejected. Example transaction responses in the adjudicated prescription billing transaction response 306 can include, but are not limited to, accepted, approved, paid, captured, denied, and denied with request for additional information and resubmission. In certain exemplary embodiments, the transaction responses can be input into a field of the prescription billing transaction 304 that is recognized by the service provider computer 104 and/or the healthcare provider computer 106. Typically, if the transaction response for the transaction 304 is approved, the adjudicated prescription billing transaction response 306 provides the amount of the cost of the medication, product, or service that will be covered by the claims processor associated with the claims processor computer 108 and the patient co-pay amount and if the transaction response is a rejection, the adjudicated prescription billing transaction response 306 provides the reason for the rejection (e.g., in the form of a reject code, for example, patient not covered, Cardholder ID submitted in the transaction is inactive, prior authorization required, medication not covered, etc.).

In step 418, the claims processor computer 108 transmits the adjudicated prescription billing transaction response 306 to the service provider computer 104 via, for example, the network 110. The service provider computer 104 receives the adjudicated prescription billing transaction response 306 from the claims processor computer 108 in step 420. In step 422, the intervention services module 148 or another portion of the service provider computer 104 can identify one or more patient identifiers in the prescription billing transaction 304. For example, the intervention services module 148 may parse the prescription billing transaction 304 to identify one or more patient identifiers, such as patient first name, patient last name, patient date of birth, patient gender, patient address (street address, city, state, zip/postal code), patient ID (e.g., HICN or social security number), cardholder ID, and/or person code. In step 424, the intervention services module 148 can compare the one or more identified patient identifiers from the prescription billing transaction 304 to the table, listing, or schedule of records of stored patient identifiers in the patient intervention eligibility files in the intervention notification files 154 to determine if a match exists. Alternatively or in addition, the intervention services module 148 can, for example based on the identified patient identifiers, conduct a real-time determination of the intervention services to be provided to the identified patient. As such, any or all of the steps of FIG. 2 may be conducted in real-time or near real-time by the intervention service module 148 and based on the identified patient identifiers in the healthcare transaction 304 to identify intervention services for the patient. Therefore, in such an alternative embodiment, steps 424-426 may or may not be completed.

In step 426, an inquiry is conducted to determine if the patient identifiers from the prescription billing transaction 304 match one or more records in the intervention notification files 154. In certain example embodiments, matching of the patient identifier information can be based on determinative matching or probabilistic matching with a configurable threshold and differing weighted values for different fields of the patient identifier information. In one example, the determination can be made by the intervention services module 148 or another portion of the service provider computer 104. If a match does not exist, the NO branch is followed to step 436. If a match does exist, the YES branch is followed optionally to step 428.

In step 428, an inquiry is conducted to determine if an intervention service is identified or otherwise suggested for the patient identified in the prescription billing transaction 304. In one example, the determination can be made by the intervention services module 148 or another portion of the service provider computer 104. For example, the intervention services module 148 can parse the one or more records from the intervention notification files 154 that matched the patient identifier to determine if those records include an indication (e.g., via code, text field, name of intervention service, field marker, etc.) to provide an identified intervention service for the patient. If an intervention service is not suggested for the patient, the NO branch is followed to step 436. On the other hand, if an intervention service is suggested for the patient in the matching record(s), the YES branch is followed to step 430. Alternatively or in addition, the intervention service module 148 or another portion of the service provider computer 104 can generate an application programming interface (API) call to another computer (e.g., the HIE computer 114, the clinical records computer 112, an EHR computer, or another third-party computer) to determine if the other computer has identified an intervention service for the patient.

In step 430, an inquiry is conducted to determine if the pharmacy that transmitted that will receive the adjudicated prescription billing transaction response 306 has previously been notified regarding this suggested intervention service for the patient with no indication that the intervention service was provided. In one example embodiment, this step is optional and the determination can be made by the intervention services module 148. For example, if the pharmacy has already been notified to provide the intervention service and, for one or more reasons, chose not to complete the intervention service, the system may be designed to not provide an additional request for the same intervention service. For example, the intervention services module 148 can parse the one or more records from the intervention notification files 154 that matched the patient identifier to determine if those records include an indication (e.g., via code, text field, pharmacy ID (e.g., NPI code, pharmacy name), field marker, etc.) that the pharmacy was previously notified of the suggested intervention service. If the pharmacy was previously notified regarding providing the suggested intervention service, the YES branch is followed to step 436. Otherwise, the NO branch is followed to step 432.

In one example embodiment, an additional, optional, step may occur prior to step 432 where the intervention services module 148 can determine if the healthcare transaction 304 includes a request for the issue being identified or remedying the issue being identified in the notification of the intervention service. For example, if the identified notification is for an intervention service related to high blood pressure for the patient, the intervention services module 148 can parse the healthcare transaction (e.g., the prescription billing transaction 304) to determine the medication/product or other service identifier (e.g., NDC code, RxNorm code, clinical test code) for the medication, product, and/or service being requested in the transaction 304. The intervention services module 148 can then compare the medication, service, or product identifier to the information in the intervention service for which a notification has been identifier to determine if the medication, service, or product identifier in the transaction 304 is for the issue identified in the intervention service. For example, a notification of intervention service may be identified for a patient that relates to high blood pressure evaluation, check-up, or other monitoring. The intervention services module 148 may parse the prescription billing transaction 304 and determine that the transaction 304 includes a request for high blood pressure medication. The intervention services module 148 may then determine that the high blood pressure medication being requested in the transaction 304 eliminates the need for the notification of intervention service and may determine to not provide the notification of intervention service. The process may then proceed to step 436. In another similar example, a notification of intervention service may be identified for a patient that relates to the patient being suggested to receive a hemoglobin A1C test as an update to the patient's blood work. The intervention services module 148 may parse the healthcare transaction 304 and determine that the transaction includes a request for the patient to receive a hemoglobin A1C test at a clinic or other healthcare provider. The intervention services module 148 may then determine that the request to receive the hemoglobin A1C test in the transaction 304 eliminates the need for the notification of intervention service and may determine not to provide the notification of intervention service. The process may then proceed to step 436. In an alternate embodiment, the intervention services module 148 may determine similar overlap between the notification of intervention service and the medication, service, or product requested in the healthcare transaction but may still determine to append the notification of intervention service to the adjudicated response 306, and thus, the process may continue to step 432.

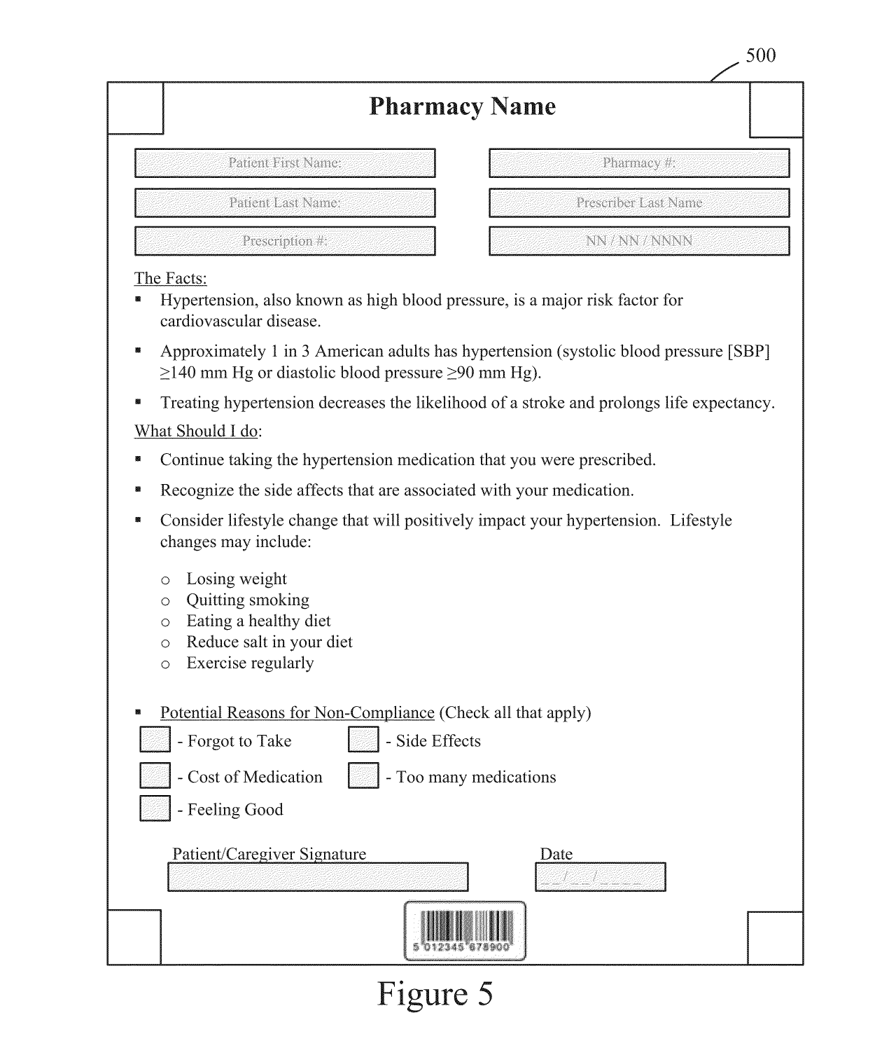

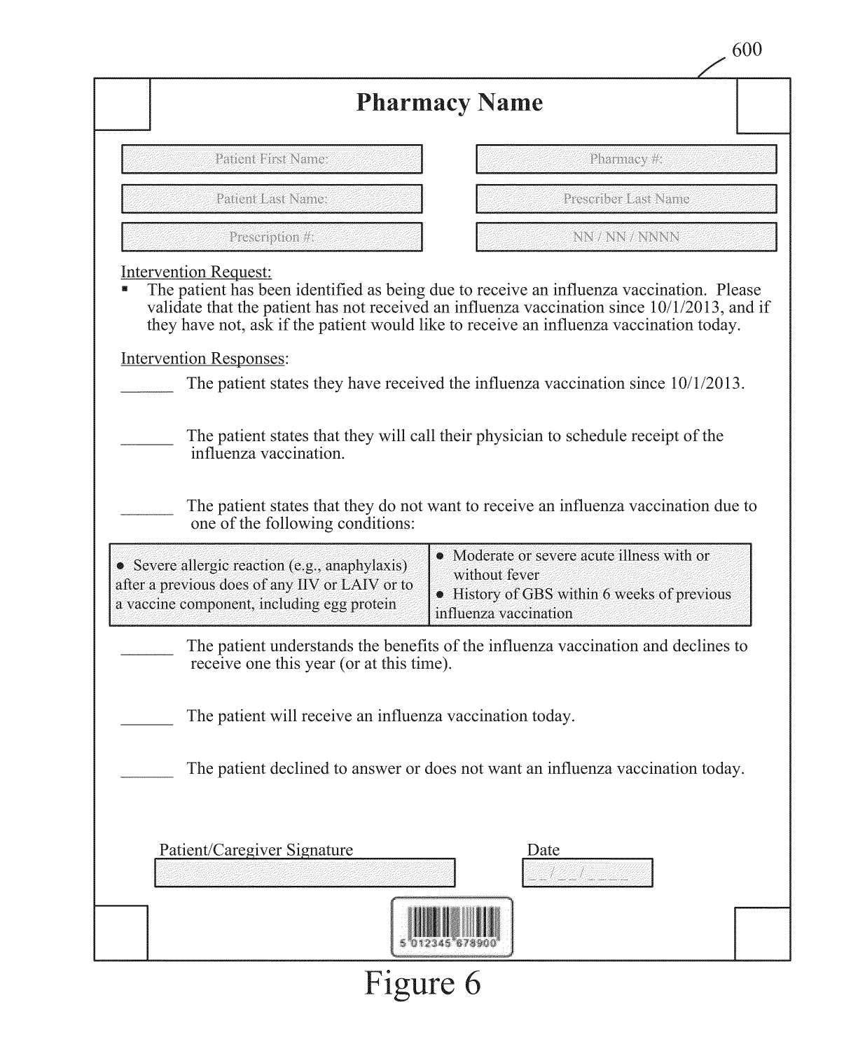

In step 432, the intervention services module 148 or another portion of the service provider computer 106 can append a notification of the suggested intervention service to the adjudicated prescription billing transaction response 306. For example, the notification can be inserted into a text field of the response 306, inserted as a code into a predetermined code field of the response 306, sent as an attachment or extension of the response 306 or sent as a separate notification from the response 306. In one example, the appended message providing notification of the suggested intervention service can take the form of an email, facsimile, text message or some other form of communication. Further, the example appending of the notification may include one or more forms 500 and/or 600 to assist the pharmacist or pharmacy employee in completing the intervention service. For example, a intervention service form may be similar to example form 500 illustrated in FIG. 5 and/or form 600 illustrated in FIG. 6. As illustrated in FIGS. 5-6, the intervention service forms 500 and 600 may include, without limitation, one or more fields including a patient first name, a patient last name, a patient date of birth, a prescription number, a pharmacy ID, and a prescriber's last name available in the transaction 304 and/or the adjudicated response 306.

The forms 500 and 600 may also include information that may be communicated from the pharmacist or other pharmacy employee to the patient. The information may be used to educate and/or re-educate the patient on the importance of medication management. For example, the identified medication may be a medication used to treat hypertension (i.e., Lisinopril). The example form 500 may include information associated with hypertension that may be communicated to the patient. For example, the template may include facts and/or statistics associated with hypertension, symptoms associated with hypertension, and/or why the patient may not be compliant with their medication. In the example form 600 of FIG. 6, information may be provided to educate the patient on the availability of a service, such as a vaccination service (e.g., an influenza vaccination) that may be provided by the pharmacist, another pharmacy employee or at the pharmacy location (e.g., an affiliated clinic at the pharmacy location). The form 600 may also provide an area for the pharmacist or pharmacy employee to record the patient's response to the offer for services. Similar information could be included in the forms 500 and 600 for any infirmity that is being suffered by the patient or service that may be offered. The intervention services module 148 or another portion of the service provider computer 104 may automatically populate the intervention services form 500 or 600 with information from the prescription billing transaction 304, the adjudicated response 306, or a combination thereof. For example, the intervention services module 148 may identify at least the patient first name, the patient last name, a patient date of birth, and a prescription/service reference number from the prescription billing transaction 304 and/or the adjudicated response 306 an insert that information into the appropriate fields of the intervention services form 500 and/or 600. In an alternative embodiment, the information presented in forms 500 and/or 600 can be in electronic form on the display of the pharmacy computer 106.

In certain example embodiments, the forms 500 and 600 can be retrieved by the intervention services module 148 from the intervention template form files 156 in the database 128. In step 434, information regarding the notification of the suggested intervention service to the pharmacy can be stored in memory or a database. For example, the information regarding the notification can be added to the identified one or more records in the intervention notification files 154 by the intervention services module 148.

In step 436, the service provider computer 104 transmits the adjudicated prescription billing transaction response 306 (either with or without a notification of suggested intervention service) to the pharmacy computer 106. In one exemplary embodiment, the adjudicated prescription billing transaction response 306 is transmitted to the pharmacy computer 106 via the network 110. The adjudicated prescription billing transaction response 306 is received by the pharmacy computer 106 in step 438. If the prescription billing transaction 304 was approved/paid and the parties agree to the financial requirements set forth in the response 306, the pharmacist or other pharmacy employee may dispense the medication to the patient in step 440. If the transaction 304 was denied, the pharmacist or other pharmacy employee may inform the patient of the denial and the basis for the denial included in the adjudicated prescription billing transaction response 306 in step 440. In step 442, the pharmacist or other pharmacy employee may note the suggested intervention service for the patient and, upon the patient coming into the pharmacy to pick up their prescription may provide the intervention service to the patient. In one example, the intervention service is an MTM service. Other examples or intervention services include, but are not limited to, providing a notification that the patient is due for an influenza shot or another type of vaccination, for a patient that has a particular infirmity that may require regular or periodic updates to clinical information, providing a notification of that the clinical information needs to be updated for the patient (e.g., the patient has diabetes and has not had their Hemoglobin A1C checked recently, and the patient should contact their physician for that test), and providing a notification that the patient is due for a blood pressure check, which could be performed in the pharmacy by the pharmacist or other pharmacy employee and then the information sent to the patient's physician (e.g., via the healthcare provider computer 106, email, facsimile message, text message, phone call, voice message, or another communication method).

If the intervention service is one for which the pharmacy may receive a fee, or if the pharmacy simply chooses to provide notification that the intervention service was provided to the patient, the pharmacy can, in certain example embodiments, submit a second healthcare transaction, such as a prescription billing transaction 308, providing notification that the intervention service was completed, and optionally providing information determined during the intervention service (e.g., information from the completed intervention service form). Alternatively, the second healthcare transaction could be a transaction type that differs from the first healthcare transaction 304. For example, the second healthcare transaction could be an eligibility file loaded directly into the pharmacy computer 106 or accessed directly by the pharmacy computer 106 via the web service.

In step 444, the second healthcare transaction 308, such as a prescription billing transaction, is generated and/or formatted at the pharmacy computer 106. In certain exemplary embodiments, the pharmacy computer 106 formats the prescription billing transaction 308 with patient information, Payor ID/routing information, and medication information. The information can be input into the prescription billing transaction 308 by the pharmacist via the I/O interface 164 or automatically retrieved and entered by the pharmacy computer 106 based at least in part on historical transaction information for the patient in the data files 168 or a database communicably coupled to the pharmacy computer 106 and/or the information form the first prescription billing request 304. According to one example embodiment, the second prescription billing transaction 306 may be formatted in a manner similar to the first transaction 304 and in accordance with a version of the National Council for Prescription Drug Programs (NCPDP) Telecommunication Standard, the American National Standards Institute (ANSI) ASC X12N 837 format, or the HL7 messaging format. In another example embodiment other messaging standards may be utilized for formatting the second prescription billing transaction 308.

The second prescription billing transaction 308 may include a BIN Number, a BIN Number and PCN, and/or a BIN Number and Group ID for identifying a particular claims processor computer (i.e., PBM, payor, healthcare insurance company, Medicare or other government healthcare insurance payor, Medicare Part D provider, etc.), such as the claims processor computer 108, as a destination for the second prescription billing transaction 308 in situations where the intervention service is one that can be billed. In addition, the second prescription billing transaction 308 may also include information relating to the patient, payor, prescriber, healthcare provider, and/or the requested medication as similarly described above with regard to the first transaction 304.

The pharmacy computer 106 transmits the second prescription billing transaction 308 to the service provider computer 104 in step 446. In step 448, the service provider computer 104 receives the second prescription billing transaction 308. For example, the second prescription billing transaction 308 can be transmitted by the pharmacy computer 106 to the service provider computer 104 through the network 110. In step 450, the intervention services module 148 or another portion of the service provider computer 106 can identify an intervention service provided in the second prescription billing transaction 308. For example, the intervention services module 148 can parse the transaction 308 and identify a code or text field identifying the intervention service and the date the intervention service was provided to the patient identified in the transaction 308.

In step 452, the intervention services module 148 or another portion of the service provider computer 104 can identify one or more patient identifiers in the second prescription billing transaction 308. For example, the intervention services module 148 may parse the second prescription billing transaction 308 to identify one or more patient identifiers, such as patient first name, patient last name, patient date of birth, patient gender, patient address (street address, city, state, zip/postal code), patient ID (e.g., HICN or social security number), cardholder ID, and/or person code. In step 454, the intervention services module 148 can compare the one or more identified patient identifiers from the second prescription billing transaction 308 to the table, listing, or schedule of records of stored patient identifiers in the patient intervention eligibility files in the intervention notification files 154 to determine if a match exists.

In step 456, an inquiry is conducted to determine if the patient identifiers from the second prescription billing transaction 308 match one or more records in the intervention notification files 154. In certain example embodiments, matching of the patient identifier information can be based on determinative matching or probabilistic matching with a configurable threshold and differing weighted values for different fields of the patient identifier information. In one example, the determination can be made by the intervention services module 148 or another portion of the service provider computer 104. If a match does not exist, the NO branch is followed to step 458, where the intervention services module 148 can generate a new intervention services record for the identified patient. The intervention services module 148 can insert the received intervention service information conducted by the pharmacy into the new record in step 460. In step 462, the intervention services module 148 can store the new record, for example, in the intervention notification files 154 of the database 128. The process may then continue to step 468.

Returning to the inquiry of step 456, if a match does exist for the identified patient, the YES branch can be followed to step 464, where the intervention services module 148 can receive the matching record(s) from, for example, the intervention notification files 154. In step 466, the intervention services module 148 can update the matching record(s) to include the provided intervention service. For example, the record can be updated to include the intervention service that was provided to the patient, the date the intervention service was provided, the pharmacy (e.g., via NPI code or pharmacy name) at which the intervention service was provided, the pharmacist (e.g., via NPI code or DEA number) that provided the intervention service, and any information determined from the intervention service (e.g., information recorded on the intervention services form). In certain examples, the service provider computer 104 and/or the intervention services module 148 may also transmit the intervention information to a separate computer system, such as an electronic health record system, a health information exchange computer 114, a clinical records computer 112, or another clinical information system. In addition, the intervention information may be transmitted to the healthcare provider via email, facsimile message, text message, phone call, or another communication method.

In certain example embodiments, the service provider computer 104 can optionally transmit the second prescription billing transaction 308 to the claims processor computer 108 for adjudication in step 468. For example, the second prescription billing transaction 308 can be transmitted from the service provider computer 104 to the claims processor computer 108 via the network 110. The claims processor computer 108 receives and adjudicates the second prescription billing transaction 308 in step 470 and generates an adjudication 310 as to whether the second prescription billing transaction 308 is approved or rejected. In step 472, the claims processor computer 108 transmits the adjudicated second prescription billing transaction response 310 to the service provider computer 104 via, for example, the network 110. The service provider computer 104 receives the adjudicated second prescription billing transaction response 310 from the claims processor computer 108 in step 474.

In step 476, the service provider computer 104 transmits the adjudicated second prescription billing transaction response 310 to the pharmacy computer 106. In one exemplary embodiment, the response 310 is transmitted to the pharmacy computer 106 via the network 110. The adjudicated second prescription billing transaction response 310 is received by the pharmacy computer 106 in step 438. In certain example embodiments, steps 468-478 may be optional as the second prescription billing transaction 308 may not be transmitted to the claims processor computer 108 for adjudication. The process may then continue to the END step.

Accordingly, example embodiments disclosed herein can provide the technical effects of creating a system and methods that provide a way to determine and communicate intervention service opportunities that may be available for a patient and to assist in the reporting and storage of documentation associated with completed intervention services as part of the processing of a healthcare transaction.

While certain example embodiments disclosed herein describe the intervention services module 148 as a processor device separate from the service provider computer 104, in alternate embodiments the intervention services module 148 or the functions that it completes may be incorporated into the service provider computer 104. In those alternate embodiments and with regard to the methods described above, the steps describing transmitting or receiving between the service provider computer 104 and the intervention services module 148 may be internal transmissions within the service provider computer 104 or may be omitted altogether. Further, while the exemplary embodiments described herein disclose certain steps occurring at the service provider computer 104 and/or the intervention services module 148, in alternative embodiments those steps described with reference to FIGS. 1-4B may alternately be completed at the healthcare provider computer 106, the claims processor computer 108, the clinical records computer 112, the health information exchange computer 114, another separate and distinct computer system, a combination of those devices, and/or a combination of those devices along with the service provider computer 104. In those alternate embodiments, certain transmission/receiving steps described above with reference to FIGS. 1-4B may be omitted while others may be added, as understood by one of ordinary skill in the art. The intent being that in alternate embodiments, any of the devices/computers discussed in FIG. 1 are capable of completing any or any part of the methods described with reference to FIGS. 2-4B.

Although example embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Furthermore, while various example implementations and architectures have been described in accordance with example embodiments of the disclosure, one of ordinary skill in the art will appreciate that numerous other modifications to the example implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and steps of the flow diagrams, and combinations of blocks in the block diagrams and steps of the flow diagrams, respectively, may be implemented by execution of computer-executable program instructions. Likewise, some blocks of the block diagrams and steps of the flow diagrams may not necessarily need to be performed in the order presented, may be performed concurrently, or may not necessarily need to be performed at all, according to some embodiments. Further, additional components and/or operations beyond those depicted in blocks of the block diagrams and/or steps of the flow diagrams may be present in certain embodiments.

Accordingly, blocks of the block diagrams and steps of the flow diagrams support combinations of means for performing the specified functions, combinations of elements or steps for performing the specified functions and program instruction means for performing the specified functions. It will also be understood that each block of the block diagrams and step of the flow diagrams, and combinations of blocks in the block diagrams and steps of the flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or steps specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium (e.g., transitory or non-transitory) produce an article of manufacture including instruction means that implement one or more functions or steps specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although example embodiments have been described in language specific to structural features and/or methodological acts, it is to be understood that the disclosure is not necessarily limited to the specific features or acts described. Rather, the specific features and acts are disclosed as illustrative forms of implementing the example embodiments. Conditional language, such as, among others, “can,” “could,” “might,” or “may,” unless specifically stated otherwise, or otherwise understood within the context as used, is generally intended to convey that certain example embodiments could include, while other example embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A computer-implemented method, comprising:
receiving, by one or more computers comprising one or more processors from a healthcare provider computer associated with a healthcare provider, a healthcare transaction comprising a product identifier for a prescribed product, and at least one patient identifier for a patient prescribed the prescribed product;
transmitting, by the one or more computers, the healthcare transaction to a claims processor computer associated with a healthcare claims processor for adjudication;
receiving, by the one or more computers from the claims processor computer, an adjudicated healthcare transaction response for the transmitted healthcare transaction;
identifying, by the one or more computers, at least a portion of the patient identifiers in the healthcare transaction;
determining, by the one or more computers and based at least in part on the identified portion of the patient identifiers, at least one intervention service to provide to the patient identified in the healthcare transaction;
generating, by the one or more computers and based at least in part on the positive determination of at least one intervention service to provide to the patient, a notification to provide the at least one intervention service;
appending, by the one or more computers, the notification to provide the at least one intervention service to the adjudicated healthcare transaction response; and
transmitting, by the one or more computers, the adjudicated healthcare transaction response and the notification to provide the at least one intervention service to the healthcare provider computer.

2. The computer-implemented method of claim 1, further comprising:
accessing, by the one or more computers, a plurality of historical healthcare transaction data for a plurality of patients;
identifying, by the one or more computers and for a first patient of the plurality of patients, a first portion of the historical healthcare transaction data comprising records for the first patient;
evaluating, by the one or more computers and for the first patient, the first portion of the historical healthcare transaction data;
determining, by the one or more computers and based on the evaluation of the first portion of the historical healthcare transaction data, the at least one intervention service to provide to the patient; and
storing, by the one or more computers, the notification of the at least one intervention service in memory.

3. The computer-implemented method of claim 2, wherein the historical healthcare transaction data comprises historical healthcare claim transaction data for a plurality of patients.

4. The computer-implemented method of claim 2, wherein the historical healthcare transaction data comprises historical clinical data for a plurality of patients.

5. The computer-implemented method of claim 1, further comprising:
receiving, by the one or more computers from the healthcare provider computer, a second healthcare transaction comprising the at least one patient identifier for the patient and an intervention service identifier for an intervention service completed by the healthcare provider for the patient;
identifying, by the one or more computers, at least a portion of the patient identifiers in the second healthcare transaction;
identifying, by the one or more computers, the intervention service identifier in the second healthcare transaction;
determining, by the one or more computers and based at least in part on the portion of the patient identifiers in the second healthcare transaction, an intervention service eligibility record for the patient; and
modifying, by the one or more computers, the intervention service eligibility record for the patient to include an indication of the completed intervention service.

6. The computer-implemented method of claim 5, further comprising:
transmitting, by the one or more computers, the second healthcare transaction to the claims processor computer for adjudication;
receiving, by the one or more computers from the claims processor computer, an adjudicated second healthcare transaction response; and
transmitting, by the one or more computers, the adjudicated second healthcare transaction response to the healthcare provider computer.

7. The computer-implemented method of claim 1, wherein appending the notification to the adjudicated healthcare transaction response comprises inserting the notification into a field of the adjudicated healthcare transaction response.

8. The computer-implemented method of claim 7, wherein the field is one of a text field and a code field.

9. The computer-implemented method of claim 1, further comprising:
identifying, by the one or more computers, an intervention services form for the determined at least one intervention service; and
transmitting, by the one or more computers, the intervention services form to the healthcare provider computer.

10. The computer-implemented method of claim 1, wherein the healthcare provider computer is a pharmacy computer and wherein the healthcare transaction is a prescription billing transaction.

11. A system comprising:
at least one memory operable to store computer-executable instructions; and
at least one processor configured to access the at least one memory and execute the computer-executable instructions to:
receive, from a healthcare provider computer associated with a healthcare provider, a healthcare transaction comprising a product identifier for a prescribed product, and at least one patient identifier for a patient prescribed the prescribed product;
direct communication of the healthcare transaction to a claims processor computer associated with a healthcare claims processor for adjudication;
receive, from the claims processor computer, an adjudicated healthcare transaction response for the transmitted healthcare transaction;
identify at least a portion of the patient identifiers in the healthcare transaction;
determine, based at least in part on the identified portion of the patient identifiers, at least one intervention service to provide to the patient identified in the healthcare transaction;
generate, based at least in part on the positive determination of at least one intervention service to provide to the patient, a notification to provide the at least one intervention service;
append the notification to provide the at least one intervention service to the adjudicated healthcare transaction response; and
direct communication of the adjudicated healthcare transaction response and the notification to provide the at least one intervention service to the healthcare provider computer.

12. The system of claim 11, wherein the at least one processor is further configured to access the at least one memory and execute the computer-executable instructions to:
access a plurality of historical healthcare transaction data for a plurality of patients;
identify, for a first patient of the plurality of patients, a first portion of the historical healthcare transaction data comprising records for the first patient;
evaluate, for the first patient, the first portion of the historical healthcare transaction data;
determine, based on the evaluation of the first portion of the historical healthcare transaction data, the at least one intervention service to provide to the patient; and
store the notification of the at least one intervention service in memory.

13. The system of claim 12, wherein the historical healthcare transaction data comprises historical healthcare claim transaction data for a plurality of patients.

14. The system of claim 12, wherein the historical healthcare transaction data comprises historical clinical data for a plurality of patients.

15. The system of claim 11, wherein the at least one processor is further configured to access the at least one memory and execute the computer-executable instructions to:
receive, from the healthcare provider computer, a second healthcare transaction comprising the at least one patient identifier for the patient and an intervention service identifier for an intervention service completed by the healthcare provider for the patient;
identify at least a portion of the patient identifiers in the second healthcare transaction;
identify the intervention service identifier in the second healthcare transaction;
determine, based at least in part on the portion of the patient identifiers in the second healthcare transaction, an intervention service eligibility record for the patient; and
modify the intervention service eligibility record for the patient to include an indication of the completed intervention service.

16. The system of claim 15, wherein the at least one processor is further configured to access the at least one memory and execute the computer-executable instructions to:
direct communication of the second healthcare transaction to the claims processor computer for adjudication;
receive, from the claims processor computer, an adjudicated second healthcare transaction response; and
direct communication of the adjudicated second healthcare transaction response to the healthcare provider computer.

17. The system of claim 11, wherein the at least one processor is configured to append the notification to the adjudicated healthcare transaction response by accessing the at least one memory and executing the computer-executable instructions to insert the notification into a field of the adjudicated healthcare transaction response.

18. The system of claim 17, wherein the field is one of a text field and a code field.

19. The system of claim 11, wherein the at least one processor is further configured to access the at least one memory and execute the computer-executable instructions to:
identify an intervention services form for the determined at least one intervention service; and
direct communication of the intervention services form to the healthcare provider computer.

20. The system of claim 11, wherein the healthcare provider computer is a pharmacy computer and wherein the healthcare transaction is a prescription billing transaction.
